(19) United States
(12) Patent Application Publication
(10) Pub. No.: US 2018/0004498 A1
(43) Pub. Date: Jan. 4, 2018

(54) SOFTWARE ACTIVATION CODE INVENTORY AND MANAGEMENT SYSTEM FOR AGRICULTURAL AND CONSTRUCTION EQUIPMENT APPLICATIONS

(71) Applicant: CNH Industrial America LLC, New Holland, PA (US)

(72) Inventor: Andrew Meyer, Prospect Heights, IL (US)

(73) Assignee: CNH INDUSTRIAL AMERICA LLC, New Holland, PA (US)

(21) Appl. No.: 14/923,800

(22) Filed: Oct. 27, 2015

(51) Int. Cl. G06F 9/445; H04W 76/02

(52) U.S. Cl. CPC G06F 8/61; H04W 76/02

(57) ABSTRACT

An activation code management system for a fleet of work vehicles includes a computing and data storage system to which vehicles in the fleet are connected for cellular data transmission. Each vehicle provides information regarding the activation codes operative thereon, and the information is compiled and reported by the computing and data storage system. The system also can obtain, retain and report actual usage of activated software.

### BACKGROUND OF THE INVENTION

### 1. Field of the Invention

The present invention relates generally to work equipment such as agricultural and construction vehicles and implements, more specifically to activation codes used for software installed in such work equipment, and still more specifically to the management of activation codes across a fleet of such equipment.

### 2. Description of the Related Art

Work equipment, such as, for example, both agricultural and construction vehicles and implements, have become increasingly more sophisticated and complex. Computer controlled functionalities provide more detailed, accurate and advantageous operation of the work equipment in multiple situations under a variety of conditions and requirements. Work equipment can be required to perform a variety of different functions at different times. For example, a tractor or other towing vehicle may be used for tilling, planting, spraying, fertilizing and harvesting. When performing these different functions, different agricultural implements are towed behind the tractor. Self-propelled harvesting equipment can be used for harvesting a variety of different crops. Construction equipment also can be used for different purposes under different operating conditions. In modern work equipment, an operator's cab is a control room for computerized systems to control and monitor not only the operation and performance of a towing vehicle but also of any implement(s) towed behind the towing vehicles, as well as to monitor ambient conditions at the work site. An in-cab display with touch-screen capabilities serves as the operator's access point for controlling and monitoring many of the functions.

It is known to provide sophisticated software packages having multiple features and uses, not all of which may be desired by a particular owner or operator of the work equipment at the time of purchase. Accordingly, a particular owner or operator might pay for some but not all functionalities available in the installed system as provided from the manufacturer, and only the desired functionalities will be enabled on the equipment as delivered. However, due to changes in use of the work equipment, at a later time an owner might have need to use other features that had been non-activated previously. Add-on software for yet further functions are available for later installation and activation. Both supplied and add-on software receive updates, improvements or upgrades and replacements, which again may require some type of activation before the software is enabled for use. In some situations, the right to use a feature or function on one system might be transferred to a different system, requiring transfer of previous activation.

Just as with software commonly known to consumers, operators and owners of work equipment frequently have the need to activate software for desired functionalities, as well as for installing upgrades, replacements and add-ons for improved and additional functionalities desired while owning the equipment. Activations of the initially acquired functions, updates, improvements, replacements, add-ons, transfers and the like often require the entry of activation codes, which are randomly generated alphanumeric sequences that may be rather short or can be quite long.

It should be appreciated that even a single work vehicle, for example, may have multiple activation codes operative at any one time. It is necessary to keep track of the activation codes if, due to happenstance it becomes necessary to reenter the activation code. A lost activation code or a code not readily accessible delays reactivation if the situation arises.

Within a fleet, work vehicles may be operating with multiple versions of the same software having been activated at different times and thus having different expiration dates. It also occurs that a particular functionality may be activated for use on one vehicle, and the vehicle seldom uses the feature; while another vehicle which has need for the feature more frequently does not have the feature activated thereon. Accordingly, a fleet may pay for unnecessary licenses. Efficient management of activation codes, by limiting waste associated with activation codes having been used for vehicles not using the features provided by the activated software can provide significant savings. Minimizing the number of different versions of software utilized across the fleet can promote efficiency through standardization. Failure to renew a license can result in untimely deactivation of the software. Avoiding deactivation of software by carefully managing renewal dates can avoid inconvenience.

What is needed in the art is an efficient method for keeping track of activation codes, the use of features applicable to the activation code, the expiration dates related to the activation codes and the like.

### SUMMARY OF THE INVENTION

The present software activation code inventory and management system uses cellular connections from individual work equipment in a fleet to provide activation codes to a single location back office for inventory and management. The single location back office provides functionality to easily manage activation codes and create reports to make decisions on software and software activations.

In one form thereof an activation code management system for a work vehicle provides at least one work vehicle with software usable only after entry of an activation code, an activation code for the software, a computing and data storage system and a cellular data transmission connection between the vehicle and the computing and data storage system. Activation code data is transmitted from the vehicle to the computing and data storage system by way of the cellular data transmission connection. At least one reports of at least some of the activation code data is generated by the computing and data storage system.

In another form thereof, an activation code management system is provided with a fleet of vehicles including individual vehicles each having software usable only after entry of an activation code, at least one activation code for the software, a computing and data storage system and cellular data transmission connections between each vehicle of the fleet of vehicles and the computing and data storage system. Activation code data is transmitted from each of the vehicles to the computing and data storage system by way of the cellular data transmission connections. Reports of at least some of the activation code data are generated by the computing and data storage system.

The invention in another form is directed to a method for managing software activation codes for a fleet of vehicles. The method includes steps of: providing a computing and data storage system; establishing cellular data transmission connections between the vehicles and the computing and data storage system; transmitting activation code data from the vehicles to the computing and data storage system by way of the cellular data transmission connections; recording the reported activation code data on the computing and storage system; reporting at least some of the activation code data on one of a read screen and a printout by the computing and data storage system; and performing a maintenance activity related to the activation codes from the reported data.

An advantage of the present invention is that activation codes can be managed for a single vehicle or multiple vehicles of the same type or of different types, the vehicles having the same or different software activated therein.

A further advantage of the present invention is that activation code management can be handled more quickly and efficiently.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is an illustration of an activation code management system; and

FIG. 2 is an illustration of one type of report available from the activation code management system.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

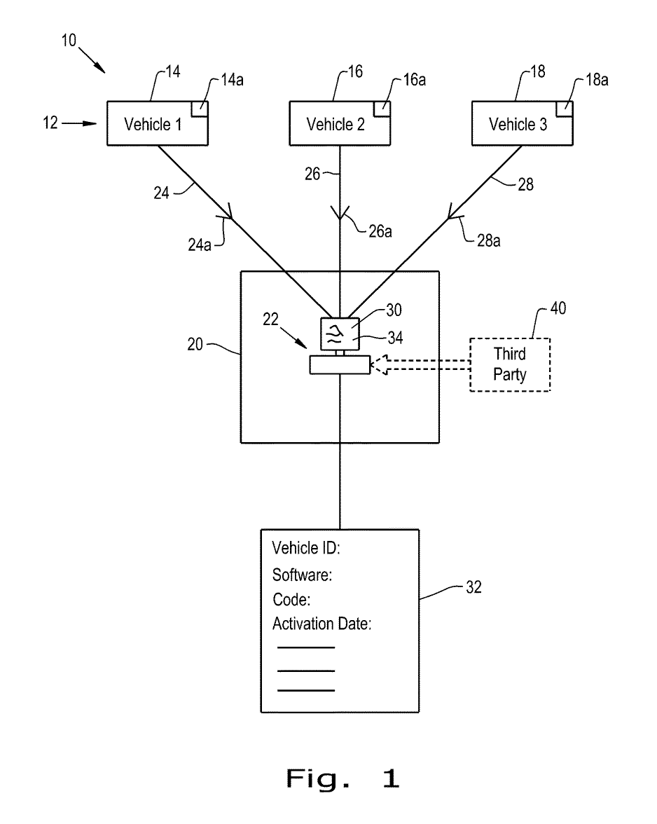

Referring now to the drawings, and more particularly to FIG. 1, there is shown an activation code management system 10 for a fleet 12 of work vehicles including individual work vehicles 14, 16, 18. Fleet 12 can consist of many different work vehicles, with three work vehicles 14, 16, 18 being shown for example. Individual work vehicles 14, 16, 18 in fleet 12 can be different or similar. For example, the individual work vehicles can consist of construction vehicles and implements, agricultural vehicles and implements, etc. In an agricultural application, a fleet of work vehicles might include, for example, several tractors of the same or different types, combines or other harvesters, other self-propelled implements such as sprayers, etc. The term “vehicle” as used herein is intended to include all types of agricultural and construction equipment such as tractors, harvesters, road graders, bulldozers, self-propelled implements and implements towed behind other equipment, etc.; and should not be considered limited to apparatus operated on roadways.

Vehicles 14, 16, 18 include software for the operation thereof that require entry of activation codes 14a, 16a, 18a before the software is made available for use. Activation codes 14a, 16a, 18a are obtained, provided and entered in any of a number of ways, as will be understood by those skilled in the art.

Fleet 12 is wirelessly connected to a back-office 20 having a computing and data storage system 22 therein. Accordingly, each vehicle 14, 16, 18 maintains a cellular data connection 24, 26, 28, respectively, to computing and data storage system 22 for the transmission of activation code data 24a, 26a, 28a from the vehicle to computing and data storage system 22. Each vehicle 14, 16, 18 informs computing and data storage system 22 of the activation codes 14a, 16a, 18a operative on the vehicle, and computing and data storage system 22 maintains an inventory of the activation codes operative on fleet 12. Typically, computing and data storage system 22 will maintain not only a list of the various activation codes and the vehicles to which each code applies, but will also maintain information identifying the software or version thereof to which the activation code applies, the installed date of the activation code, the expiration date for the activation code, etc.

As part of its activation code data 24a, 26a, 28a, each vehicle 14, 16, 18 also can transmit to computing and data storage system 22 information regarding the frequency and/or duration of occurrences when an activated software or feature is in use. In this way, computing and data storage system 22 can maintain a use history for each vehicle in fleet 12 and can provide tabulated data regarding actual use of installed software on each vehicle 14, 16, 18, as well as across fleet 12 generally.

From the data received and stored by computing and data storage system 22 from vehicles 14, 16, 18, computing and data storage system 22 provides functionality to manage activation codes and create view screens 30 and/or reports 32 to make decisions on software or software activations. The back-office database of the information can be viewed using software or a web portal. The software and/or web portal enables management of activation codes across individual vehicles, multiple vehicles or entire fleet 12. For example, using the stored data, alerts can be generated within a set period of time before renewal of an activation code is required. Further, from actual use reports, decisions can be made to renew, cancel and/or transfer activation codes among vehicles using activated software frequently or infrequently.

Computing and data storage system 22 also may acquire, retain and process third-party information and data 40. Third-party data 40 may include, for example, information from the provider of software to which the activation codes apply. Accordingly, reports 32 and view screens 30 can include information from the outside sources to facilitate decisions regarding renewal, removal, activation, transfer etc. for the software and vehicles.

Computing and data storage system 22 can generate standard reports as designed by the user and special reports as requested from time to time by the user. Reports generated by computing and data storage system 22 may include, for example and not limitation, lists of software versions currently being used and available activation codes not yet purchased, software currently being used and activation codes needing renewal; software currently being used and activation codes currently expired; software not currently being used and available activation codes not yet purchased; software not currently being used and activation codes needing renewal soon; software not currently being used and activation codes currently expired; time of usage for vehicles and current activation codes and software versions as sortable lists or graphs; usage data and type of software features/functionalities on vehicles and associated activation codes, etc. It should be understood that the above exemplary reports and other reports can be compiled for each individual vehicle, for a group of vehicles, or for fleet 12 as a whole.

Review of reports on a view screen 30 by way of a web portal or a computer in computing and data storage system 22 can include one or more activity button 34 for identified information and decision enacting functions directly on the screen. For example, a list of soon to expire activation code licenses can include a column having a button for renewal, which when selected and activated will link to an appropriate website or page for processing a renewal. On-screen transfer from one vehicle to another (if allowed by the license), on-screen renewal or purchase, and on-screen removal or cancellation are just some of the features that can be included as activity buttons 34 of a view screen 30 to complete a maintenance activity for an activation code. Of course, performing a maintenance activity can be achieved in other ways, such as, for example, independent online performance of the activity, performing the activity by mail or by telephone, etc.

Customer or dealer support also can be provided access to the database of information for use in troubleshooting and for providing assistance with software activations and/or issues relating to the software.

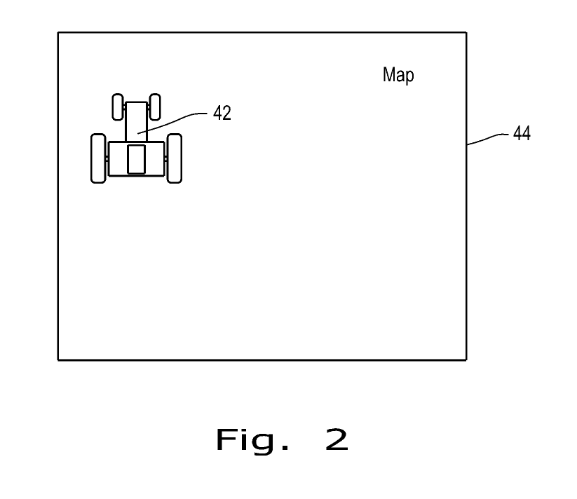

Referring now to FIG. 2, with the use of global positioning software, computing and data storage system 22 can track the locations of any or all vehicles in fleet 12 and can display the locations thereof as an icon 42 positioned on a map 44. Icons 42 representative of each vehicle chosen can be selected and isolated to provide detailed information regarding the activation codes operative thereon, such as, the software version applicable, installation date, expiration date, frequency of use, etc. Data such as that found in view screen 30 and/or report 32 described previously can be included, as well as performance and operating information of the selected vehicle or vehicles useful for fleet management.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An activation code management system for a work vehicle, comprising:
at least one work vehicle with software to operate the work vehicle usable only after entry of an activation code;
an activation code for said software;
a computing and data storage system;
a cellular data transmission connection between said at least one vehicle and said computing and data storage system;
activation code data transmitted from said at least one vehicle to said computing and data storage system by way of said cellular data transmission connection; and
at least one report of at least some of said activation code data generated by said computing and data storage system.

2. The activation code management system of claim 1, wherein:
said at least one work vehicle is part of a fleet including other work vehicles having software usable only after entry of activation codes;
other cellular data transmission connections between said other work vehicles and said computing and data storage system; and
said activation code data includes data transmitted from said other work vehicles to said computing and data storage system by way of said other cellular data transmission connections

3. The activation code management system of claim 2, wherein:
said reports include a visual display of a map, and at least a part of said fleet is located on said map.

4. The activation code management system of claim 2, wherein:
said activation code data includes use data of software associated with said activation codes for at least some vehicles of said fleet.

5. The activation code management system of claim 2, wherein:
said computing and data storage system includes third-party data and information.

6. The activation code management system of claim 5, wherein:
said activation code data includes use data of software associated with said activation codes for at least some vehicles of said fleet.

7. The activation code management system of claim 1, wherein:
said activation code data includes use data of said software.

8. The activation code management system of claim 1, wherein:
said computing and data storage system includes third-party data and information.

9. The activation code management system of claim 1, wherein:
said computing and data storage system generates a read screen having at least one activity button thereon related to management activities for said activation code including at least one of purchasing, renewing, transferring and canceling.

10. An activation code management system, comprising:
a fleet of vehicles including individual vehicles each having software used to operate said individual vehicles usable only after entry of an activation code;
at least one activation code for said software;
a computing and data storage system;
cellular data transmission connections between each vehicle of said fleet of vehicles and said computing and data storage system;
activation code data transmitted from each of said vehicles to said computing and data storage system by way of said cellular data transmission connections; and
reports of at least some of said activation code data generated by said computing and data storage system.

11. The activation code management system of claim 10, wherein:
said reports include a visual display of a map and at least some of said vehicles positioned on said map.

12. The activation code management system of claim 11, wherein:
said activation code data includes use data for at least some vehicles of said fleet.

13. The activation code management system of claim 11, wherein:
said computing and data storage system includes third-party data and information.

14. The activation code management system of claim 13, wherein:
said activation code data includes use data for at least some vehicles of said fleet.

15. The activation code management system of claim 10, wherein:
said computing and data storage system includes third-party data and information.

16. The activation code management system of claim 10, wherein:
said computing and data storage system generates a read screen including at least one activity button for at least one of purchasing, renewing, transferring and canceling an activation code for at least one vehicle reported on said read screen.

17. A method for managing software activation codes for a fleet of vehicles, comprising the steps of:
providing a computing and data storage system;
establishing cellular data transmission connections between the vehicles and the computing and data storage system;
transmitting activation code data from the vehicles to the computing and data storage system by way of the cellular data transmission connections, the activation code data being associated with software that operates individual vehicles of the fleet of vehicles only upon entry of an activation code;
recording the reported activation code data on the computing and storage system;
reporting at least some of said activation code data on one of a read screen and a printout by the computing and data storage; and
performing a maintenance activity related to the activation codes from the reported data.

18. The method for managing software activation codes of claim 17, wherein
said step of reporting includes generating a map and positioning at least some vehicles of the fleet of vehicles on the map.

19. The method for managing software activation codes of claim 17, wherein:
said step of transmitting activation code data includes transmitting usage of software associated with an activation code.

20. The method for managing software activation codes of claim 17, further including a step of obtaining and recording third-party data and information by the computing and storage system.
